(19) United States
(12) Patent Application Publication
(10) Pub. No.: US 2010/0192128 A1
(43) Pub. Date: Jul. 29, 2010

(54) SYSTEM AND METHODS OF USING TEST POINTS AND SIGNAL OVERRIDES IN REQUIREMENTS-BASED TEST GENERATION

(75) Inventors: Kirk A. Schloegel, Independence, MN (US); Devesh Bhatt, Maple Grove, MN (US); Steve Hickman, Eagan, MN (US); David V. Oglesby, Brooklyn Center, MN (US); Manish Patodi, Bangalore (IN); VenkataRaman Perivela, Bangalore (IN); Rachana Labh, Bangalore (IN)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/360,743

(22) Filed: Jan. 27, 2009

(51) Int. Cl. G06F 11/36

(52) U.S. Cl. 717/125

(57) ABSTRACT

An electronic system for test generation is disclosed. The system comprises a source code generator, a test generator, and a code and test equivalence indicator, each of which take functional requirements of a design model as input. The test generator generates test cases for a first test set and a second test set, where the first test set comprises a target source code without references to test points in the source code and the second test set comprises a test equivalent source code that references the test points of the source code. The code and test equivalency indicator generates test metrics for the first and second test sets and comparatively determines whether the target source code is functionally identical to the test equivalent source code based on an analysis of the test metrics and a comparison of the target and the test equivalent source codes.

### CROSS REFERENCE TO RELATED APPLICATIONS

This application is related to the following commonly assigned and co-pending U.S. Patent Applications, each of which are incorporated herein by reference in their entirety:

U.S. patent application Ser. No. 11/945,021, filed on Nov. 27, 2007 and entitled “REQUIREMENTS-BASED TEST GENERATION” (the '021 Application);

U.S. Provisional Patent Application Ser. No. 61/053,205, filed on May 14, 2008 and entitled “METHOD AND APPARATUS FOR HYBRID TEST GENERATION FROM DIAGRAMS WITH COMBINED DATA FLOW AND STATECHART NOTATION” (the '205 Application);

U.S. patent application Ser. No. 12/136,146, filed on Jun. 10, 2008 and entitled “A METHOD, APPARATUS, AND SYSTEM FOR AUTOMATIC TEST GENERATION FROM STATECHARTS” (the '146 Application); and

U.S. patent application Ser. No. 12/247,882, filed on Oct. 8, 2008 and entitled “METHOD AND APPARATUS FOR TEST GENERATION FROM HYBRID DIAGRAMS WITH COMBINED DATA FLOW AND STATECHART NOTATION” (the '882 Application).

### BACKGROUND

Typically, automatic generation of functional and functional-equivalency tests from computer simulation models is an extensive task even for state-of-the-art simulation tools. This ability to generate equivalency tests is exacerbated for models with complex data flow structures or feedback loops. A common testing approach involves using global test points that are implicit within generated computer source code and machine language instructions used in constructing the test cases for the simulation models.

However, these global test points generally require global variables that preclude certain source-level code and machine-level optimizations from being performed, resulting in negative effects in the operational throughput of a resulting product. In addition, if these test points are removed after testing, additional analysis of the source code is required, particularly when the resulting product requires industry certification as a saleable product.

### SUMMARY

The following specification provides for a system and methods of using test points and signal overrides in requirements-based test generation. Particularly, in one embodiment, an electronic system for test generation is provided. The system comprises a source code generator, a test generator, and a code and test equivalence indicator, each of which take functional requirements of a design model as input. The design model comprising functional requirements of a system under test. The source code generator generates source code from the design model. The test generator generates test cases for a first test set and a second test set, where the first test set comprises a target source code without references to test points in the source code and the second test set comprises a test equivalent source code that references the test points of the source code. The code and test equivalence indicator generates test metrics for the first and second test sets and comparatively determines whether the target source code is functionally identical to the test equivalent source code based on an analysis of the test metrics and a comparison of the target and the test equivalent source codes.

### BRIEF DESCRIPTION OF THE DRAWINGS

These and other features, aspects, and advantages are better understood with regard to the following description, appended claims, and accompanying drawings where:

FIG. 1 is a flow diagram of an embodiment of a conventional system development process;

FIG. 2 is a block diagram of an embodiment of a computing device;

FIG. 3 is a model of using test points in requirements-based test generation;

FIG. 4 is a flow diagram of an embodiment of a system process of using test points in requirements-based test generation;

FIG. 5 is a flow diagram of an embodiment of a process of comparing source code to determine code equivalence in the process of FIG. 4;

FIG. 6 is a flow diagram of an embodiment of a process of comparing test cases to determine test equivalence in the process of FIG. 4;

FIG. 7 is a flow diagram of an embodiment of a process of comparing test cases to determine test equivalence in the process of FIG. 4;

FIG. 8 is a flow diagram of an embodiment of a process of comparing test cases to determine test equivalence in the process of FIG. 4;

FIG. 9 is a flow diagram of an embodiment of a system process of using signal overrides in requirements-based test generation; and

FIG. 10 is a model of using signal overrides in requirements-based test generation.

The various described features are drawn to emphasize features relevant to the embodiments disclosed. Like reference characters denote like elements throughout the figures and text of the specification.

### DETAILED DESCRIPTION

Embodiments disclosed herein relate to a system and methods of using test points and signal overrides in requirements-based test generation. For example, at least one embodiment relates to using test points and signal overrides for validation of machine language instructions, implemented as source code listings, requiring industry certification prior to release. In particular, at least one method discussed herein details the issues associated with enabling test points and adding signal overrides into computer simulation models to improve test coverage. In one implementation, an automated system approach improves test coverage for validation of the source code listings without affecting the throughput of the final release of a particular product requiring industry certification.

Embodiments disclosed herein represent at least one method for (1) generating multiple sets of source code for different purposes, (2) showing equivalence between them, and then (3) performing a different function on each of the sets of source code. In particular, at least one embodiment discussed in further detail below provides both “throughput optimized” and “testing optimized” source codes that can be used to improve throughput on a set of “target” hardware and improve automated testing throughput during verification.

In addition, the embodiments disclosed herein are applicable in generating further types of source code (for example, a “security analysis optimized” or a “resource usage optimized” source code). The system and methods discussed herein will indicate equivalence between these types of optimized sets of source code and a target source code, and as such, be able to provide security certification or evidence to show that the optimized sets of source code can operate and function on a resource-constrained embedded system.

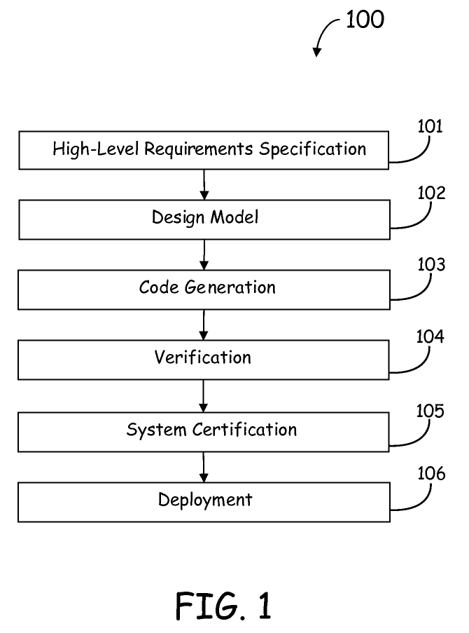

FIG. 1 is a flow diagram of an embodiment of a conventional development process for a navigation control system. As addressed in FIG. 1, implementation verification is one aspect of the development process. In one embodiment, a development team identifies a need for a particular type of navigation control system and specifies high-level functional requirements that address this need (block 101). The development team correspondingly proceeds with the design of a model (block 102). The result of the design model is a functional model of a system that addresses the need specified in block 101.

In the process of FIG. 1, machine-readable code is generated from the design model that represents the functional requirements of a system or component, either manually by the developer or automatically by some computer program capable of realizing the model (block 103). This step can also include compiling the code and/or linking the code to existing code libraries. The generated code is verified according to industry standard objectives like the Federal Aviation Administration (FAA) DO-178B standard for aviation control systems (block 104). Due to the rigor of the certification objectives, verifying the code is disproportionately expensive, both in time and in system resources. Because existing test generation programs do not generate a complete set of test cases, developers will manually generate test cases that prove the model conforms to its requirements (for example, as per the DO-178B, Software Considerations in Airborne Systems and Equipment Certification standard). Once system testing has been achieved, the system is certified (block 105). The certified system is deployed in industry; for instance, as a navigation control system to be incorporated into the avionics of an aircraft (block 106).

In the example embodiment of FIG. 1, data flow block diagrams are used to model specific algorithms for parts of the control system such as flight controls, engine controls, and navigation systems. These algorithms are designed to execute repeatedly, over one or more time steps, during the operational life of the system. The purpose of test case generation is to verify that the object code (or other implementation of the data flow block diagram, alternately termed a data flow diagram) correctly implements the algorithm specified by the block diagram.

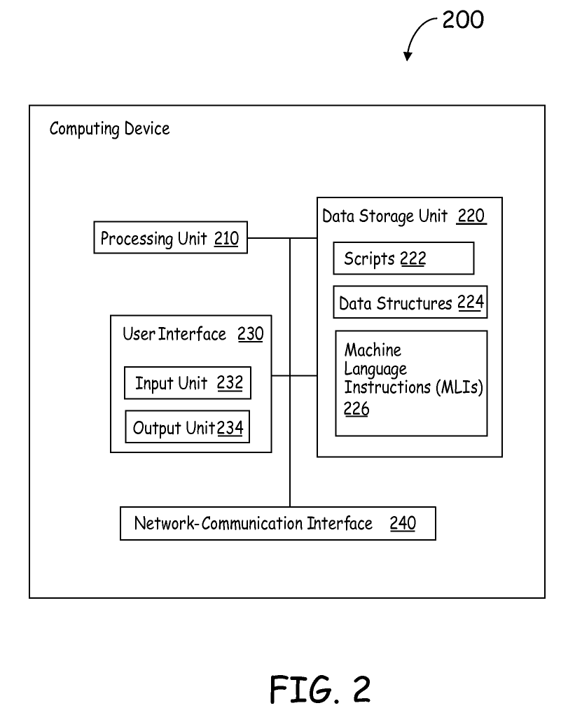

FIG. 2 is a block diagram of an embodiment of a computing device 200, comprising a processing unit 210, a data storage unit 220, a user interface 230, and a network-communication interface 240. In the example embodiment of FIG. 2, the computing device 200 is one of a desktop computer, a notebook computer, a personal data assistant (PDA), a mobile phone, or any similar device that is equipped with a processing unit capable of executing computer instructions that implement at least part of the herein-described functionality of a particular test generation tool that provides code and test equivalence in requirements-based test generation.

The processing unit 210 comprises one or more central processing units, computer processors, mobile processors, digital signal processors (DSPs), microprocessors, computer chips, and similar processing units now known or later developed to execute machine-language instructions and process data. The data storage unit 220 comprises one or more storage devices. In the example embodiment of FIG. 2, the data storage unit 220 can include read-only memory (ROM), random access memory (RAM), removable-disk-drive memory, hard-disk memory, magnetic-tape memory, flash memory, or similar storage devices now known or later developed.

The data storage unit 220 comprises at least enough storage capacity to contain one or more scripts 222, data structures 224, and machine-language instructions 226. The data structures 224 comprise at least any environments, lists, markings of states and transitions, vectors (including multi-step vectors and output test vectors), human-readable forms, markings, and any other data structures described herein required to perform some or all of the functions of the herein-described test generator, source code generator, test executor, and computer simulation models.

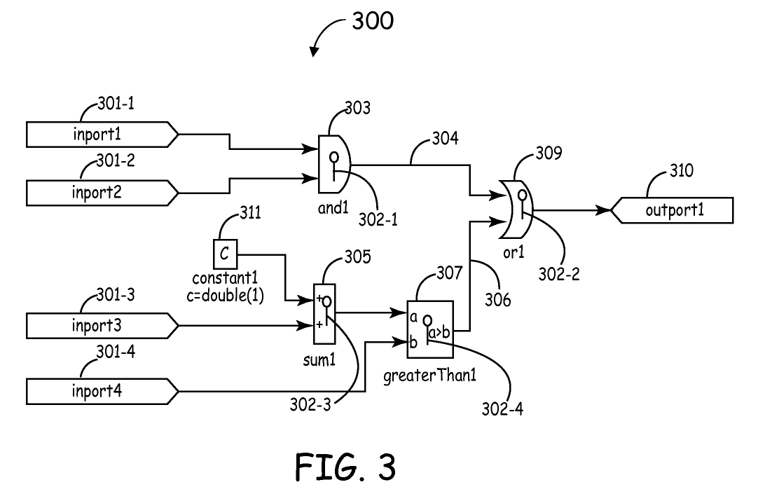

For example, a test generator such as the Honeywell Integrated Lifecycle Tools & Environment (HiLiTE) test generator implements the requirements-based test generation discussed herein. The computing device 200 is used to implement the test generator and perform some or all of the procedures described below with respect to FIGS. 3-10, where the test generation methods are implemented as machine language instructions to be stored in the data storage unit 220 of the computing device 200. In addition, the data structures 224 perform some or all of the procedures described below with respect to FIGS. 3-10. The machine-language instructions 226 contained in the data storage unit 220 include instructions executable by the processing unit 210 to perform some or all of the functions of the herein-described test generator, source code generator, test executor, and computer simulation models. In addition, the machine-language instructions 226 and the user interface 230 perform some or all of the procedures described below with respect to FIGS. 3-10.

In the example embodiment of FIG. 2, the user interface 230 comprises an input unit 232 and an output unit 234. The input unit 232 receives user input from a user of the computing device 230. In one implementation, the input unit 232 includes one of a keyboard, a keypad, a touch screen, a computer mouse, a track ball, a joystick, or other similar devices, now known or later developed, capable of receiving the user input from the user. The output unit 234 provides output to the user of the computing device 230. In one implementation, the output unit 234 includes one or more cathode ray tubes (CRT), liquid crystal displays (LCD), light emitting diodes (LEDs), displays using digital light processing (DLP) technology, printers, light bulbs, and other similar devices, now known or later developed, capable of displaying graphical, textual, or numerical information to the user of the computing device 200.

The network-communication interface 240 sends and receives data and includes at least one of a wired-communication interface and a wireless-communication interface. The wired-communication interface, when present, comprises one of a wire, cable, fiber-optic link, or similar physical connection to a particular wide area network (WAN), a local area network (LAN), one or more public data networks, such as the Internet, one or more private data networks, or any combination of such networks. The wireless-communication interface, when present, utilizes an air interface, such as an IEEE 802.11 (Wi-Fi) interface to the particular WAN, LAN, public data networks, private data networks, or combination of such networks.

FIG. 3 is an embodiment of a data flow block diagram 300 to model at least one specific algorithm for parts of a control system such as flight controls, engine controls, and navigation systems. These algorithms are designed to execute repeatedly as at least a portion of the functional machine-language instructions generated by the process of FIG. 1 using the computing device of FIG. 2, over one or more time steps, during the operational life of the system, as discussed in further detail in the '021 and '146 Applications. For example, the data flow block diagram 300 is a directed, possibly cyclic, diagram where each node in the diagram performs some type of function, and the arcs connecting nodes indicate how data and/or control signals flow from one node to another. A node of the data flow diagram 300 is also called a block (the two terms are used interchangeably herein), and each block has a block type.

The nodes shown in the diagram of FIG. 3 have multiple incoming arcs and multiple outgoing arcs. Each end of the arcs is connected to a node via one or more ports. The ports are unidirectional (that is, information flows either in or out of a port, but not both). For example, as shown in FIG. 3, a node 303 has two input ports that receive its input signals from nodes 301-1 and 301-2, and one output port that sends its output signals to a node 309 via an arc 304. Nodes like the input ports 301-1 and 301-2 that have no incoming arcs are considered input blocks and represent diagram-level inputs. Nodes like the output port 310 that have no outgoing arcs are considered output blocks and represent diagram-level outputs.

As shown in FIG. 3, each of the blocks are represented by icons of various shapes to visually denote the specific function performed by a particular block, where the block is an instance of that particular block's block type. Typically, each block type has an industry-standard icon. The block type defines specific characteristics, including functionality, which is shared by the blocks of that block type. Examples of block type include filter, timer, sum, product, range limit, AND, and OR. (Herein, to avoid confusion, logical functions such as OR and AND are referred to using all capital letters). Moreover, each block type dictates a quantity, or type and range characteristics, of the input and output ports of the blocks of that block type. For example, an AND block 303 (labeled and1) is an AND gate, where the two inputs to the block 303, input1 (301-1) and input2 (301-2), are logically combined to produce an output along arc 304. Similarly, an OR block 309 (labeled or1) is an OR gate, where the output of the arc 304 and an output from a decision block 307 are logically combined to produce an output at the output port 310. The diagram 300 further comprises block 311 (constant1) and block 305 (labeled sum1).

As further shown in FIG. 3, the requirements-based test generation discussed herein further comprises test points 302-1 to 302-4 (shown in FIG. 3 as enabling implicit test points within the blocks 303, 305, 307, and 309). The test points 302 eliminate any need to propagate the output values of a particular block under test all the way downstream to the model output at the output port 3 10. Instead, these values will only be propagated to the nearest test point. The test points 302 allow the output values of all the blocks 303, 305, 307, and 309 to be measured directly regardless of whether or not they are directly tied to the output port 310. For example, the test point 302-1 eliminates the need to compute values for the input port 301-3 (inport3) and the input port 301-4 (inport4) when testing the AND block 303, since there is no longer a need to propagate the and1 output value to outport1. The values for inport3 and inport4 can be “don't care” values for the and1 tests when the test point 302-1 is enabled.

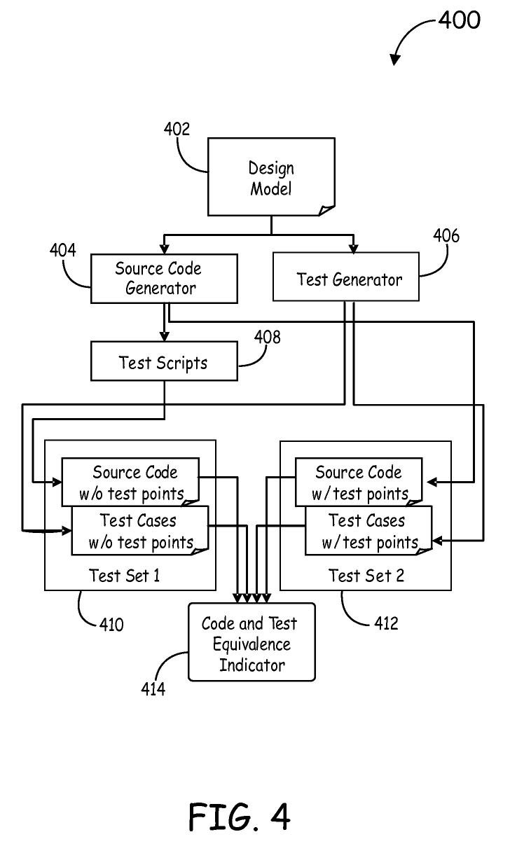

In one implementation, and as discussed in further detail below with respect to FIGS. 4 to 8, each test point is represented by a global variable that is directly measured by a particular test executor to verify an expected output value. For example, the test points 302 are set on the output signals for each of their respective blocks. This effectively sets an implicit test point after every block, and further results in the global variable being defined to hold a test point value.

As discussed in further detail below with respect to FIG. 4, as the existence of test points reduces the throughput performance of “target” source code generated for the control system modeled by the diagram 300, the test points 302 are disabled in the source code by post-processing the target source code to convert the global variables representing these test points into local variables. In one implementation, special-purpose scripts are used to transform the target source code to result in “source code without test points.” The purpose of transforming the target source code is to disable all the test points that are internal to the blocks to improve the throughput performance of the target source code. For example, the target source code is modified by the scripts to disable the test points. This results in two sets of source code. The source code that keeps the test points enabled by not running the post-processing scripts is referred to herein as the “test equivalent” source code or the “source code with test points.”

For each set of source code an associated set of test cases are generated by an automatic test generator such as HiLiTE. Each set of source code along with its associated set of test case are referred to herein as a “test set” as shown in FIG. 4. The target source code and associated test cases are referred to as the “first test set.” The test equivalent source code and associated test cases are referred to as the “second test set.” Accordingly, code and test equivalence is shown between the first and second test sets using the processes discussed below with respect to FIGS. 4 to 8.

FIG. 4 is a flow diagram of an embodiment of a system process, shown generally at 400, of using test points in requirements-based test generation. The process 400 comprises a design model 402 that is input to a source code generator 404 and a test generator 406. In the example embodiment of FIG. 4, the source code generator 404 generates a plurality of source code with test points. These are input into test scripts 408 to result in source code without test points. Moreover, the test generator 406 can be the HiLiTE test generator discussed above with respect to FIG. 2. The design model 402 is a computer simulation model that provides predetermined inputs for one or more test cases in the process 400. In one implementation, test cases are generated using the design model 402 to provide inputs for the requirements-based test generation discussed herein.

The process shown in FIG. 4 illustrates an approach that will improve requirements and structural coverage of the test cases while not impacting throughput by using two sets of source code and test cases 410 and 412, labeled “Test Set 1” and “Test Set 2.” In the example embodiment of FIG. 4, the first test set 410 comprises the source code and test cases for requirements-based certification testing, where the source code of the first test set 410 represents the actual target source code for a final product and does not contain test points. The second test set 412 comprises test equivalent source code of the actual target source code and does contain test points.

The target source code for the first test set 410 is the result of running the test scripts 408 on the source code generated from the source code generator 404. The test scripts 408 disable any test points (for example, make the test point variables local instead of global) as described above with respect to FIG. 3. The test generator 406 generates the test cases for each of the Test Sets 1 and 2. In one embodiment, the test generator 406 includes a test generator command file that specifies that one or more of the test points from the source code generator 404 be disabled in the first test set 410. The second test set 412 will have the test points of the source code enabled to improve requirements and structural coverage of tests generated by the test generator 406 for the design model 402. In one implementation, the source code for the second test set 412 uses standard options from the source code generator 404, where the test points are available as global variables.

Similarly, the test cases for the first test set 410 will come from a first run of the test generator 406, specifying in a command file for the test generator 406 that the test points are disabled for the first test set 410. Alternatively, when test cases that are not generated in the first test set 410 are generated for the test cases in the second test set 412, a list of only the additional test cases for the second set of test cases is provided in the command file for the test generator 406. In one implementation, these second set of test cases for the second test set 412 complete any requirements and structural coverage that is not achieved with the test cases for the first test set 410.

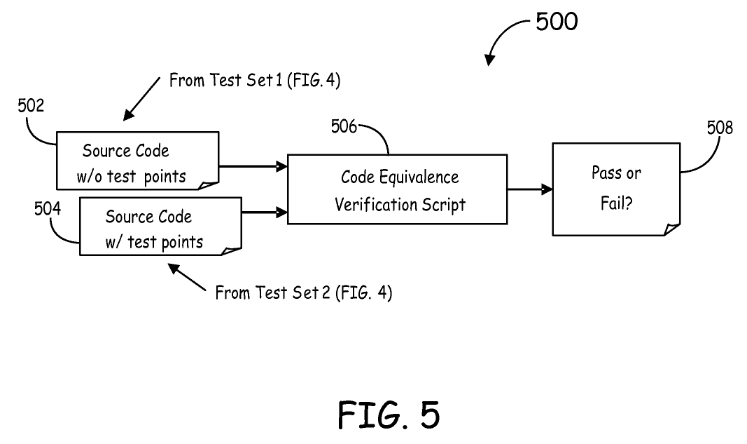

As discussed in further detail below with respect to FIGS. 5 to 8, functional equivalence and structural equivalence (that is, code equivalence) will be shown between the two sets of code via a code and test equivalence indicator 414 that receives results from the test sets 410 and 412. Furthermore, test equivalence will be shown between the two sets of tests via the code and test equivalence indicator 414. This enables the functional requirements and the structural coverage of the second test set 412 to meet predetermined product and certification standards when the source code in the first test set 410 is used as the target source code for the final product.

In operation, the test generator 406 generates test cases for the first test set 410 and the second test set 412. The source code generator 404 generates test equivalent source code for the second test set 412. In one implementation, the test script 408 is executed on the target equivalent source code to generate the target source code for the first test set 410.

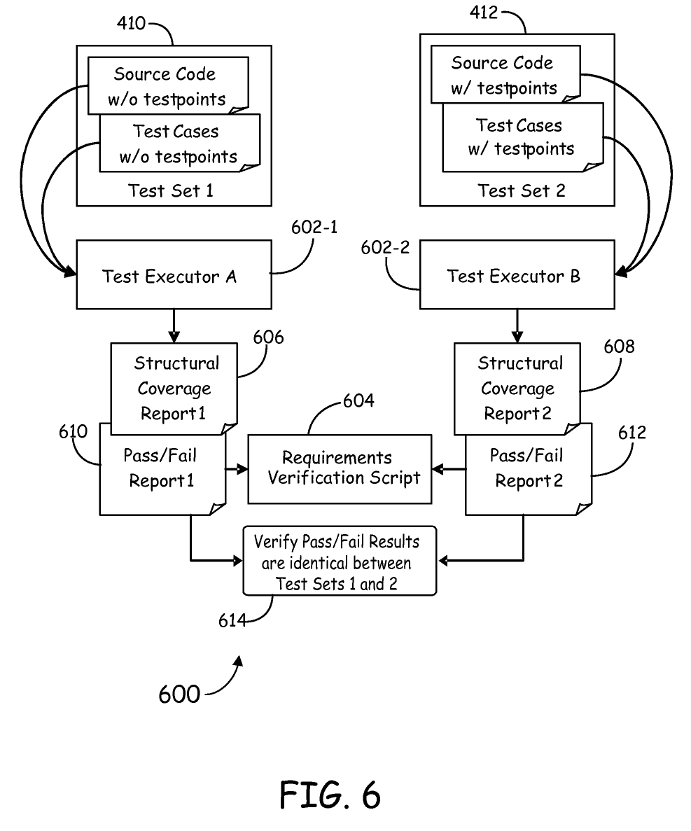

The code and test equivalence indicator 414 runs the first and second test sets on a test executor, as discussed in further detail below with respect to FIGS. 6 to 8. The test executor can be a test harness, target hardware, simulator, or an emulator. The code and test equivalence indicator 414 produces test metrics from each test set run. The test metrics can include data regarding structural coverage achieved, data regarding requirements coverage achieved, pass/fail results of the test runs, timing results of test runs, or a variety of other measured, observed, or aggregated results from one or more of the test runs.

Based on the performance of the test cases of the first and the second test sets 410 and 412, the code and test equivalence indicator 414 analyzes the generated test metrics of the first test set 410 and the second test set 412 and compares the source code of the second test set 412 for structural and operational equivalence with the source code of the first test set 410 to determine whether the source code in the second test set 412 is functionally equivalent to the source code in the first test set 410.

### Code Equivalence

FIG. 5 is a flow diagram, indicated generally at reference numeral 500, of an embodiment of a process of comparing source code to determine code equivalence used by the code and test equivalence indicator 414 in the process of FIG. 4. With reference to the first and second test sets described above with respect to FIG. 4, enabling test points in a test equivalent source code 504 will result in code that is structurally and functionally (that is, with respect to implementation of requirements) equivalent to a target source code 502 that is created with the test points disabled.

One method to show code equivalence is to show structural equivalence. In this method, to show structural equivalence is to show that the only differences between sets of code will be differences in non-structural code characteristics. For example, the variables used to store the signals with the test points disabled in the target source code 502 will be local variables that are not visible outside the source code generator 404, while the variables that store the signals with an associated (and enabled) test point are generated as global variables that are visible outside the source code generator 404. This difference in no way affects either the function (that is, the implementation of requirements) or the structure of the generated code.

For example, as shown in FIG. 5, a code equivalence verification script 506 is generated for the code and test equivalence indicator 414 in the process of FIG. 4 to automatically check the two sets of source code 502 and 504. The code equivalence verification script 506 verifies that the only difference between the two sets of the source code is the existence of the test points in the test equivalent source code 504 (pass/fail block 508). The code equivalence verification script 506 ensures that the two versions of the source code are equivalent from the perspective of any predetermined product requirements as well as the code structure. For example, in one implementation, the code equivalence verification script 506 can be qualified along with the test generator to show equivalency between the two versions of the source code with a substantially high level of confidence.

A second method to show code equivalence is to compare and analyze test metrics resulting from runs of test sets on a test executor. The process of using test points to provide code and test equivalence described above with respect to FIGS. 4 and 5 provides evidence that the two versions of the source code are equivalent from the perspectives of the predetermined product requirements as well as the subsequently generated code structure. Other methods of showing code equivalence are also possible. It is possible to use one or more methods in conjunction, depending on the cost of showing code equivalence versus the degree of confidence required.

In addition, as discussed in further detail below with respect to FIGS. 6 to 8, the two sets of test cases will be shown to be equivalent (in terms of correctly testing the predetermined product requirements) when run on the first and second test sets 410 and 412.

### Test Equivalence

FIG. 6 is a flow diagram, indicated generally at reference numeral 600, of an embodiment of a process of comparing test cases to determine test equivalence used by the code and test equivalence indicator 414 in the process of FIG. 4. As shown in FIG. 6, each of the first and the second test sets 410 and 412 are executed on test executor A (block 602-1) and test executor B (block 602-2), respectively. In addition, test executor A and test executor B each generate first and second structural coverage reports 606 and 608 (labeled “Structural Coverage Report 1” and “Structural Coverage Report 2”), and first and second pass/fail reports 610 and 612 (labeled “Pass/Fail Report 1” and “Pass/Fail Report 2”), respectively. In the example embodiment of FIG. 6, a requirements verification script 604 verifies the set of requirements that were tested in the test executors A and B for each of the first and the second test sets 410 and 412 overlap in particular ways.

In one implementation, the second test set 412 covers a “superset” of the requirements covered by the first test set 410. This “requirements superset” can be verified by a qualified version of the requirements verification script 604 to result in a substantially higher level of confidence in the result. In addition, the pass/fail results from the first and second reports 610 and 612 are verified to be identical (for example, all tests pass in each set) at block 614. This verification step provides evidence that the two sets of tests are equivalent in terms of the particular requirements being tested. In one embodiment, the test generator 406 of FIG. 4 is a qualified test generation tool that generates proper test cases for each specific requirement to provide a guarantee of correct and equivalent tests to a substantially high level of confidence. When the second set of test cases is run on the second set of code, a complete set of requirements and structural coverage can be achieved that cannot be achieved with the first set of test cases. Once both sets of the code are shown to be structurally and operationally equivalent, the complete requirements and structural coverage has been achieved on the first set of code (that is, the target code for the final product).

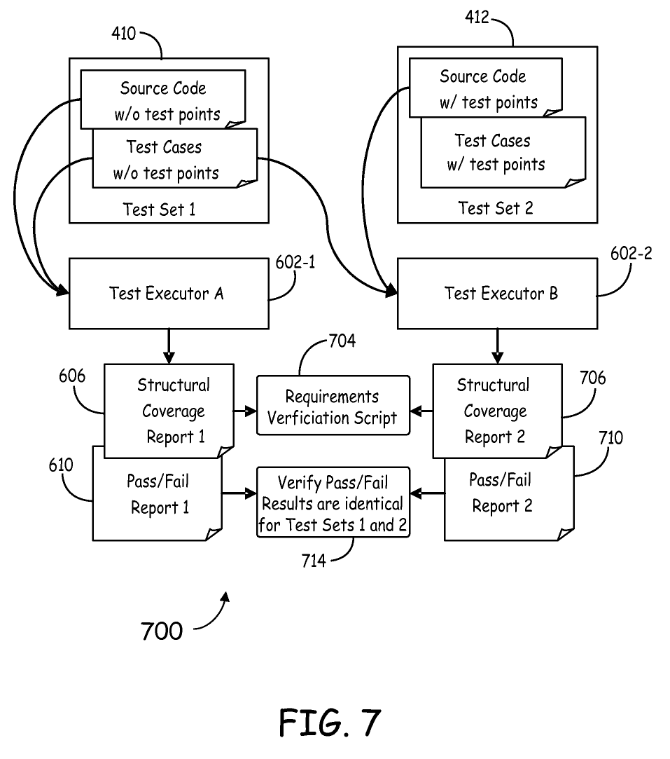

FIG. 7 is a flow diagram, indicated generally at reference numeral 700, of an embodiment of a process of comparing test cases to determine test equivalence with the code and test equivalence indicator 414 in the process of FIG. 4. In one embodiment, the process shown in FIG. 7 is a first extension of the process discussed above with respect to FIG. 6. FIG. 7 provides a substantially greater degree of confidence in test equivalence. As shown in FIG. 7, the first test set 410 is executed on the test executor A (block 602-1). The test executor A generates the first structural coverage report 606 and the first pass/fail report 610.

In addition, the process 700 executes the test cases of the first test set 410 (without test points) on the test executor B (block 602-2) using the source code of the second test set 412 (with test points). As a result, the test executor B generates a second structural coverage report 706 and a second pass/fail report 710. Similar to the process discussed above with respect to FIG. 6, a requirements verification script 704 verifies the requirements that were tested in test executor A and test executor B for each of the first and the second test sets 410 and 412 overlap. In addition, the pass/fail results from the first pass/fail report 610 and the second pass/fail report 710 are verified to be identical (for example, all tests pass in each set) at block 714.

With reference back to the process of FIG. 4, since the test cases in both the first and the second test sets 410 and 412 do not rely on test points (only on simulation model inputs and outputs of the simulator 402), the test cases in the first test set 410 operate for both the first and the second test sets 410 and 412. In the example embodiment of FIG. 7, the test pass/fail and structural coverage results will be identical for the first and the second test sets 410 and 412 to ensure that the two versions of the test cases are equivalent with respect to functional testing of the requirements. This extension strengthens the evidence for test equivalence established in the process discussed above with respect to FIG. 6.

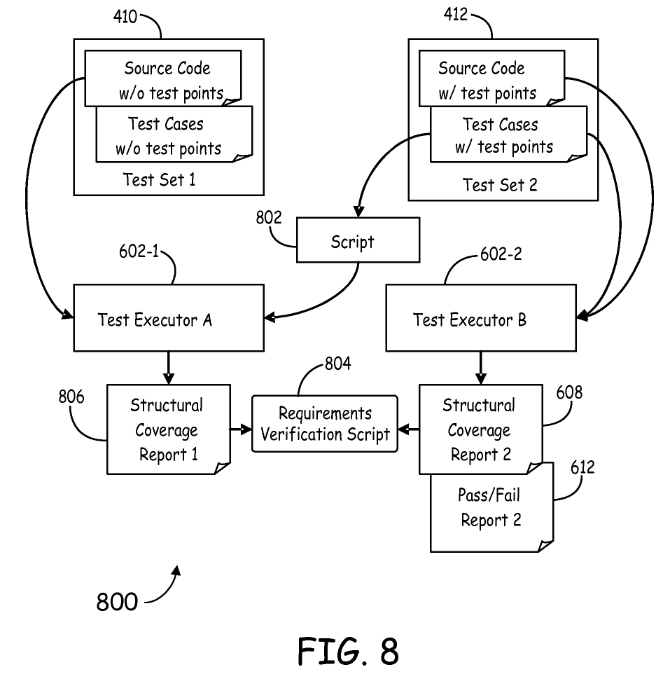

FIG. 8 is a flow diagram, indicated generally at reference numeral 800, of an embodiment of a process of comparing test cases to determine test equivalence used by the code and test equivalence indicator 414 in the process of FIG. 4. In one embodiment, the process shown in FIG. 8 is a second extension of the process discussed above with respect to FIG. 6. FIG. 8 similarly provides a greater degree of confidence. As shown in FIG. 8, the source code of the first test set 410 and the test cases of the second test set 412 are executed on the test executor A (block 602-1), and the source code and the test cases for the second test set 412 are executed on the test executor B (block 602-2). The test executor A generates a structural coverage report 806, and the test executor B generates a similar structural coverage report 608 and pass/fail report 612 as discussed above with respect to FIG. 6.

In the process of FIG. 8, the structural and/or requirements coverage results will again match since the same sequence of simulation model input values is applied to both the first and the second test sets 410 and 412. Since running the test cases of the second test set 412 on the source code for the first test set 410, the test cases of the second test set 412 will reference the values of global variables for the test points that are not present in the source code for the first test set 410. Accordingly, a script 802 will remove the expected output references and values that correspond to the test point global variables. As a result, the structural and/or requirements coverage is achieved for the test equivalent source code of the second test set 412 without the measurement of expected output values. The script 802 can be qualified to show that the output references and values were correctly removed with a substantially high level of confidence.

### Signal Overrides

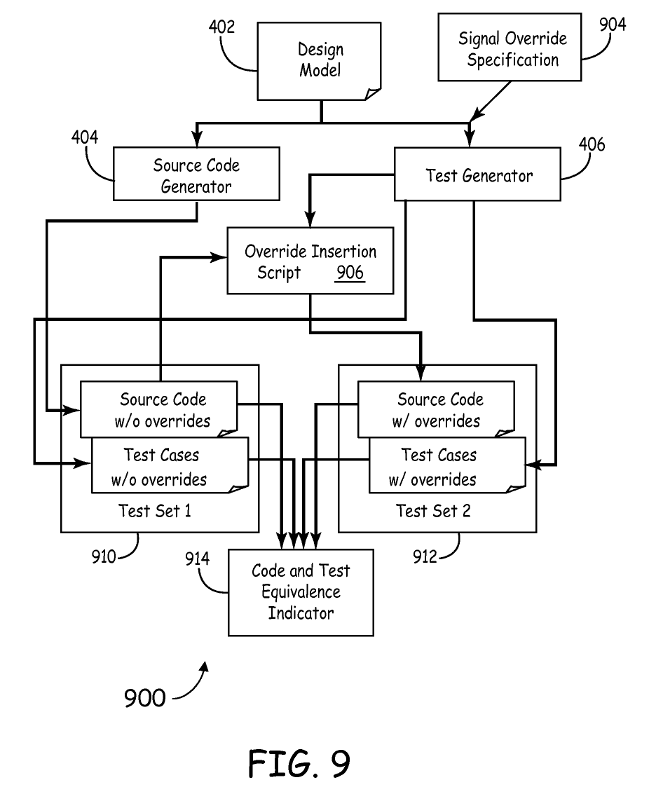

FIG. 9 is a flow diagram of an embodiment of a system process 900 of using signal overrides in requirements-based test generation. Similar to the process discussed above with respect to FIG. 4, the process shown in FIG. 9 comprises the design model 402 that is input to the source code generator 404 and the test generator 406. The process of FIG. 9 uses signal overrides to determine code and test equivalence between a first (baseline) test set 910, labeled “Test Set 1,” and a second (augmented) test set 912, labeled “Test Set 2,” by inserting at least one implicit signal override into the source code of the first test set 910 using scripts (shown in FIG. 9 as “Override Insertion Script” in block 906) for the source code of the second test set 912. The override insertion script 906 can be qualified to show that the source code was correctly modified with a substantially high level of confidence.

Similar to the process discussed above with respect to FIG. 4, requirements-implementation and structural equivalence (that is, code equivalence) will be shown between the two sets of code via a code and test equivalence indicator 914 that receives results from both the baseline test set 910 and the augmented test set 912. The process 900 addresses improvements to auto-test generation coverage without affecting throughput in an analogous process to the system process for test points discussed above with respect to FIG. 4. In one implementation, a primary difference of the processes shown in FIGS. 4 and 9 is that qualified scripts are disabling the test points in FIG. 4 and inserting the implicit signal override in the augmented test set 912. In addition, the implicit signal override also makes test generation significantly easier by allowing internal signals to be set to arbitrary values externally by a signal override specification (block 904) and overriding the internally produced value for that signal.

In operation, the test generator 406 generates test cases for the first test set 910 and the second test set 912. The source code generator 404 generates the target source code without the signal overrides of the first test set 910. In one implementation, the override insertion script 906 is executed on the target source code of the first test set 910 to generate test equivalent source code of the second test set with the signal overrides. A test executor (for example, the test executor 602 of FIGS. 6 to 8) runs each test set and generates test metrics.

Based on the performance of the test cases of the first and the second test sets 910 and 912, the code and test equivalence indicator 914 analyzes the generated test metrics of the first test set 910 and the second test set 912 and compares the source code of the second test set 912 for structural and operational equivalence with the source code of the first test set 910 to determine whether the source code in the second test set 912 (with the signal overrides enabled) is functionally equivalent to the source code of the first test set 910.

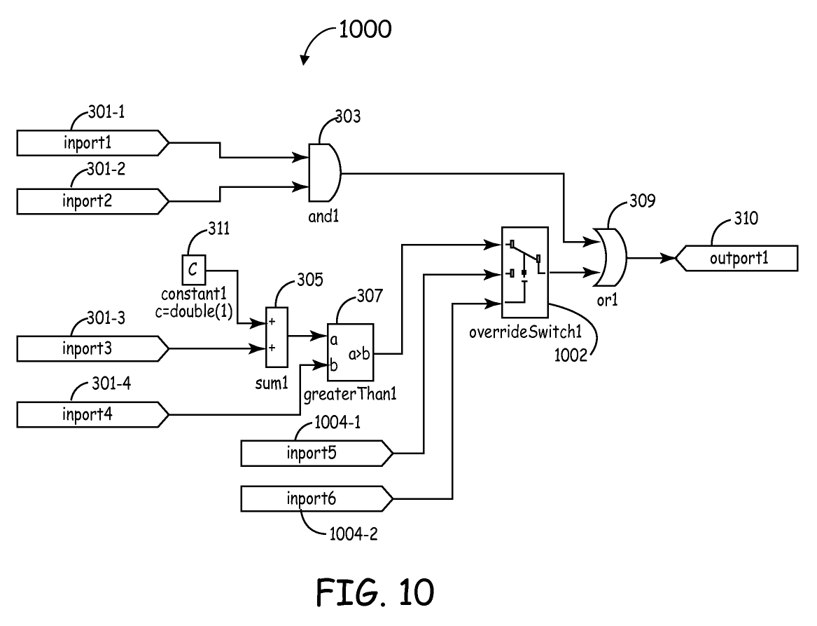

As a further example, FIG. 10 shows an explicit override switch 1002 added to the model from FIG. 3. This override is implemented by the switch overrideSwitch1 and the two additional model inputs, 1004-1 and 1004-2 (shown as inport5 and inport6 in FIG. 10). For example, when inport6 is false, the model behaves as in FIG. 3. As a result, the second input of or1 (block 309) is determined by the output of greaterThan1 (block 307). In one implementation, inport6 will be tied to false for the final product. When inport6 is true, the second input of or1 is determined directly by the value of inport5. This precludes having to propagate values from inport3 and inport4 (blocks 301-3 and 301-4) in order to achieve a predetermined value.

Explicit signal overrides (for example, the signal overrides 1004-1 and shown in FIG. 10) add additional object code to be executed. Alternatively, enabling implicit overrides by using the signal override specification 904 of FIG. 9 on the source code: (1) adds a global variable to shadow the variable implementing the signal; (2) ensures this “shadow variable” is set as specified by the signal override specification at block 904 of FIG. 9, and (3) changes all statements in the generated code that normally read the value of the “original” signal variable to instead read the value of the shadow variable. The advantage of this approach is that the models do not change, nor does the structure of the generated code.

The methods and techniques described herein may be implemented in a combination of digital electronic circuitry and can be realized by hardware, executable modules stored on a computer readable medium, or a combination of both. An apparatus embodying these techniques may include appropriate input and output devices, a programmable processor, and a storage medium tangibly embodying program instructions for execution by the programmable processor. A process embodying these techniques may be performed by the programmable processor executing a program of instructions that operates on input data and generates appropriate output data. The techniques may be implemented in one or more programs executable on a programmable system including at least one programmable processor coupled to receive data and instructions from (and to transmit data and instructions to) a data storage system, at least one input device, and at least one output device. Generally, the processor will receive instructions and data from at least one of a read only memory (ROM) and a random access memory (RAM). In addition, storage media suitable for tangibly embodying computer program instructions and data include all forms of non-volatile memory, and include by way of example, semiconductor memory devices; magnetic disks such as internal hard disks and removable disks; magneto-optical discs; optical discs, and other computer-readable media. Any of the foregoing may be supplemented by, or incorporated in, specially-designed application-specific integrated circuits (ASICs).

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also included within the scope of computer-readable media.

This description has been presented for purposes of illustration, and is not intended to be exhaustive or limited to the embodiments disclosed. Variations and modifications may occur, which fall within the scope of the following claims.

What is claimed is:

1. An electronic system for test generation, comprising:
a design model, the design model comprising functional requirements of a system under test;
a source code generator that takes the functional requirements of the design model as input, the source code generator operable to generate source code from the design model;
a test generator that takes the functional requirements of the design model as input, the test generator operable to generate test cases for a first test set and a second test set, the first test set comprising a target source code without references to test points in the source code and the second test set comprising a test equivalent source code that references the test points of the source code; and
a code and test equivalence indicator communicatively coupled to the source code generator and the test generator, the code and test equivalence indicator operable to:
generate test metrics for the first and the second test sets, and
comparatively determine whether the target source code is functionally identical to the test equivalent source code based on an analysis of the test metrics and a comparison of the target and the test equivalent source codes.

2. The system of claim 1, wherein the test generator is further operable to:
execute a test script on the test equivalent source code to disable one or more of the test points so as to produce the target source code.

3. The system of claim 1, wherein the test generator is further operable to:
execute an override insertion script on the target source code to enable at least one implicit signal override so as to produce the test equivalent source code.

4. The system of claim 1, wherein the test generator is further operable to:
enable an explicit signal override using a signal override specification for the test equivalent source code in the second test set.

5. The system of claim 1, wherein the code and test equivalence indicator is operable to:
execute the first test set on a first test executor;
execute the second test set on a second test executor; and
generate first and second structural coverage reports to indicate via a requirements verification script that one or more predetermined product requirements tested in the first and the second test executors for each of the first and the second test sets overlap.

6. The system of claim 1, wherein the code and test equivalence indicator is operable to:
execute the target source code and the test cases of the first test set on a first test executor;
execute the test cases of the first test set and the test equivalent source code on a second test executor; and
generate first and second structural coverage reports to indicate via a requirements verification script that one or more predetermined product requirements tested in the first and the second test executors for each of the first and the second test sets overlap.

7. The system of claim 1, wherein the code and test equivalence indicator is operable to:
execute the target source code and the test cases of the second test set on a first test executor;
execute the test equivalent source code and the test cases of the second test set on a second test executor; and
generate first and second structural coverage reports to indicate via a requirements verification script that one or more predetermined product requirements tested in the first and the second test executors for each of the first and the second test sets overlap.

8. The system of claim 1, wherein the design model is operable to generate executable machine-language instructions contained in a computer-readable storage medium of a component for a navigation control system.

9. The system of claim 1, further comprising a user interface for comparing that the source code in the second test set is structurally and operationally equivalent to the source code in the first test set.

10. The system of claim 9, wherein comparing that the source code in the second test set is structurally and operationally equivalent to the source code in the first test set comprises outputting the comparison via an output unit of the user interface.

11. A method of using test points for requirements-based test generation, the method comprising:
generating test cases for a first test set and a second test set, the first test set comprising a first source code and the second test set comprising a second source code, each of the first and the second source codes further including test points;
specifying that the test points be disabled in at least the source code of the first test set;
performing the test cases for the first and the second source codes on a test executor; and
based on the performance of the test cases of the first and the second test sets, analyzing test metrics of the executed first and the second test sets and comparing the source code of the second test set with the source code of the first test set to determine whether the source code in the second test set is functionally equivalent to the source code in the first test set.

12. The method of claim 11, wherein performing the test cases for the first and the second source codes comprises executing a test script on the first source code to disable the test points.

13. The method of claim 11, wherein performing the test cases for the first and the second source codes further comprises:
executing the first test set on a first test executor;
executing the second test set on a second test executor; and
generating first and second structural coverage reports to indicate that one or more predetermined product requirements tested in the first and the second test executors for each of the first and the second test sets overlap.

14. The method of claim 11, wherein performing the test cases for the first and the second source codes further comprises:
executing the source code of the first test set and the test cases of the first test set on a first test executor;
executing the test cases of the first test set and the source code of the second test set on a second test executor; and
generating first and second structural coverage reports to indicate that one or more predetermined product requirements tested in the first and the second test executors for each of the first and the second test sets overlap.

15. The method of claim 11, wherein performing the test cases for the first and the second source codes further comprises:
executing the source code of the first test set and the test cases of the second test set on a first test executor;
executing the source code of the second test set and the test cases of the second test set on a second test executor; and
generating first and second structural coverage reports to indicate that one or more predetermined product requirements tested in the first and the second test executors overlap.

16. A computer program product comprising:
a computer-readable storage medium having executable machine-language instructions for implementing the method of using test points for requirements-based test generation according to claim 11.

17. A method of using signal overrides for requirements-based test generation, the method comprising:
generating test cases for a first test set and a second test set, the first test set comprising a first source code and the second test set comprising a second source code, each of the first and the second source codes further including signal overrides;
enabling the signal overrides in at least the source code of the second test set;
performing the test cases for the first and the second source codes on a test executor; and
based on the performance of the test cases of the first and the second test sets, analyzing test metrics of the executed first and the second test sets and comparing the source code of the second test set with the source code of the first test set to determine whether the source code in the second test set is functionally equivalent to the source code in the first test set.

18. The method of claim 17, wherein enabling the signal overrides in at least the source code of the second test set comprises executing an override insertion script on the second source code.

19. The method of claim 17, wherein analyzing the test metrics of the executed first and the second test sets and comparing the source code of the second test set with the source code of the first test set comprises indicating that the source code of the second test set is structurally and operationally equivalent to the source code of the first test set.

20. A computer program product comprising:
a computer-readable storage medium having executable machine-language instructions for implementing the method of using signal overrides for requirements-based test generation according to claim 17.
